(19) United States
(12) Patent Application Publication
(10) Pub. No.: US 2026/0075510 A1
(43) Pub. Date: Mar. 12, 2026

(54) MOBILE TERMINATION-BASED SLICE RESELECTION METHOD AND DEVICE IN NEXT GENERATION MOBILE COMMUNICATION SYSTEM

(71) Applicant: Samsung Electronics Co., Ltd., Gyeonggi-do (KR)

(72) Inventors: Sangyeob JUNG, Gyeonggi-do (KR); Anil AGIWAL, Gyeonggi-do (KR)

(21) Appl. No.: 19/105,205

(22) PCT Filed: Aug. 22, 2023
(86) PCT No.: PCT/KR2023/012390

§ 371 Date: Feb. 20, 2025

(30) Foreign Application Priority Data
Aug. 24, 2022 (KR) 10-2022-0106170

(51) Int. Cl. H04W 48/18; H04W 28/086

(52) U.S. Cl. CPC H04W 48/18; H04W 28/086

(57) ABSTRACT

The disclosure relates to a 5G or 6G communication system for supporting a higher data transmission rate. According to the present disclosure, a terminal in an RRC connection mode in a mobile communication system can report intended slice information to a base station.

### TECHNICAL FIELD

The disclosure relates to a user equipment (UE) and base station operations in a mobile communication system. More particularly, the disclosure relates to a method of reporting slice information intended by a UE in a RRC-connected mode to a base station.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries. IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Meanwhile, it is required for the UE to report intended slice information to a base station (BS) in the mobile communication system.

### DETAILED DESCRIPTION OF INVENTION

### Technical Problem

In a mobile communication system, a method by which a terminal in a RRC-connected mode reports intended slice information to a base station is needed.

### Technical Solution

A method performed by a user equipment (UE) in a wireless communication system according to an embodiment of the disclosure to solve the problem may include transmitting, to a first base station (BS). UE capability information indicating whether a report on preference information associated with intended slice group information of the UE is supported, receiving, from the first BS, a first radio resource control (RRC) reconfiguration message including configuration information for the report on the preference information associated with the intended slice group information, and transmitting, to the first BS, a first message including the preference information associated with the intended slice group information, based on the configuration information.

A method performed by a first base station (BS) in a wireless communication system according to another embodiment of the disclosure may include receiving, from a user equipment (UE), UE capability information indicating whether a report on preference information associated with intended slice group information of the UE is supported, generating a first radio resource control (RRC) reconfiguration message including configuration information for the report on the preference information associated with the intended slice group information and transmitting the first RRC reconfiguration message to the UE, and receiving, from the UE, a first message including the preference information associated with the intended slice group information identified based on the configuration information.

A user equipment (UE) in a wireless communication system according to another embodiment of the disclosure may include a transceiver, and a controller configured to perform control to transmit UE capability information indicating whether a report on preference information associated with intended slice group information of the UE is supported to a first base station (BS) through the transceiver, receive a first radio resource control (RRC) reconfiguration message including configuration information for the report on the preference information associated with the intended slice group information from the first BS through the transceiver, and transmit a first message including the preference information associated with the intended slice group information to the first BS through the transceiver, based on the configuration information.

A first base station (BS) in a wireless communication system according to another embodiment of the disclosure may include a transceiver, and a controller configured to perform control to receive UE capability information indicating whether a report on preference information associated with intended slice group information of the UE is supported from a user equipment (UE) through the transceiver, generate a first radio resource control (RRC) reconfiguration message including configuration information for the report on the preference information associated with the intended slice group information and transmitting the first RRC reconfiguration message to the UE through the transceiver, and receive a first message including the preference information associated with the intended slice group information identified based on the configuration information from the UE through the transceiver.

### Effects of Invention

According to embodiments of the disclosure, a UE in a RRC-connected mode may efficiently report intended slice information to a BS.

### BRIEF DESCRIPTION OF DRAWINGS

FIG. 1 is a diagram illustrating the structure of an LTE system according to an embodiment of the disclosure.

FIG. 2 is a diagram illustrating a wireless protocol structure in an LTE system according to an embodiment of the disclosure.

FIG. 3 is a diagram illustrating the structure of a next-generation mobile communication system according to an embodiment of the disclosure.

FIG. 4 is a diagram illustrating the wireless protocol structure of the next-generation mobile communication system according to an embodiment of the disclosure.

FIG. 5 is a diagram illustrating a process in which the UE receives a configuration of slice groups and a slice group priority through the access and mobility management function (AMF) in the next-generation mobile communication system.

FIG. 6 is a diagram illustrating a method by which the UE reports intended slice information to the gNB in the next-generation mobile communication system.

FIG. 7 is a diagram illustrating a method by which the UE reports intended slice information to the gNB in the next-generation mobile communication system.

FIG. 8 is a diagram illustrating a method by which the UE reports intended slice information to the gNB in the next-generation mobile communication system.

FIG. 9 is a block diagram illustrating an internal structure of the UE according to an embodiment of the disclosure.

FIG. 10 is a block diagram illustrating a configuration of the NR gNB according to an embodiment of the disclosure.

### MODE FOR CARRYING OUT INVENTION

Hereinafter, the principle of operation of the disclosure will be described in detail with reference to the accompanying drawings. In describing the present disclosure below, a detailed description of related known configurations or functions incorporated herein will be omitted when it is determined that the detailed description thereof may unnecessarily obscure the subject matter of the disclosure. The terms which will be used below are terms defined in consideration of the functions in the disclosure, and may differ according to users, intentions of users, or customs. Therefore, the definitions of the terms should be made based on the contents throughout the specification.

In the following description of the disclosure, a detailed description of known configurations or functions incorporated herein will be omitted when it is determined that the detailed description may make the subject matter of the disclosure unclear. Hereinafter, embodiments of the disclosure will be described with reference to the accompanying drawings.

Terms for identifying access nodes used in the following description, terms referring to network entities, terms referring to messages, terms referring to interfaces between network entities, and terms referring to various pieces of identification information are used for convenience of description. Therefore, the disclosure is not limited to the terminologies provided below, and other terms that indicate subjects having equivalent technical meanings may be used.

For convenience of description, the disclosure uses terms and names defined in a 3^{rd}-generation partnership project long-term evolution (3GPP LTE) standard. However, the disclosure is not limited to the above terms and names, and may be equally applied to a system according to another standard. In the disclosure, the term “eNB” may be interchangeable with “gNB” for convenience of description. That is, a BS described as an eNB may indicate a gNB.

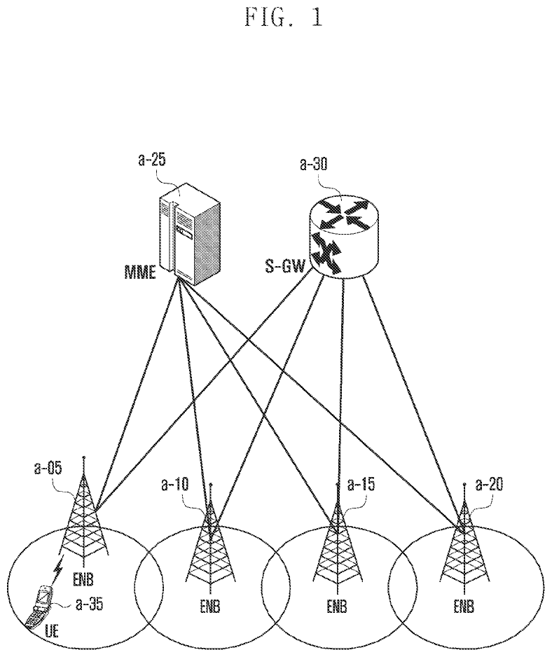

FIG. 1 is a diagram illustrating the structure of an LTE system according to an embodiment of the disclosure.

Referring to FIG. 1, as illustrated, a radio access network of the LTE system is constituted by next-generation base stations (evolved node Bs, hereinafter referred to as ENBs, Node Bs, or base stations) a-05, a-10, a-15, and a-20, a mobility management entity (MME) a-25, and a serving gateway (S-GW) a-30. A user terminal (user equipment (UE), hereinafter referred to as a UE or a terminal) a-35 accesses an external network through the ENBs a-05 to a-20 and the S-GW a-30.

In FIG. 1, the ENBs a-05 to a-20 correspond to the conventional node Bs of the UMTS system. The ENB is connected to the UE a-35 through a radio channel, and performs a more complicated role than that of the conventional node B. In the LTE system, since all user traffic including a real-time service such as voice over IP (VoIP) via an Internet protocol is served through a shared channel, a device for collecting and scheduling status information such as buffer statuses of UEs, available transmission power statuses, and channel statuses is required, and the ENBs a-05 to a-20 may serve as this device. One ENB generally controls a plurality of cells. For, example, in order to implement a transmission rate of 100 Mbps, the LTE system uses an Orthogonal Frequency Division Multiplexing (OFDM) as a radio access technology in a bandwidth of 20 MHz. Further, an adaptive modulation and coding (AMC) scheme of determining a modulation scheme and a channel coding rate is applied depending on the channel status of the UE. The S-GW a-30 is a device that provides a data bearer, and generates or removes the data bearers according to the control of the MME a-25. The MME is a device for performing not only a function of managing mobility of the UE but also various control functions and is connected to a plurality of ENBs.

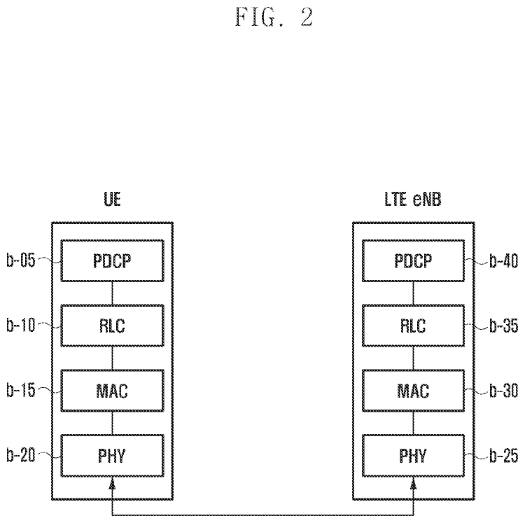

FIG. 2 is a diagram illustrating a wireless protocol structure in the LTE system according to an embodiment of the disclosure.

Referring to FIG. 2, the wireless protocol of the LTE system includes packet data convergence protocols (PDCPs) b-05 and b-40, radio link controls (RLCs) b-10 and b-35, and medium access controls (MACs) b-15 and b-30 in the UE and the ENB. The packet data convergence protocols (PDCPs) b-05 and b-40 perform an operation of compressing/reconstructing an IP header. Main functions of the PDCP are described below.
Header compression and decompression function (Header compression and decompression: ROHC only)
User data transmission function (Transfer of user data)
Sequential delivery function (In-sequence delivery of upper layer PDUs at PDCP re-establishment procedure for RLC AM)
Reordering function (For split bearers in DC (only support for RLC AM): PDCP PDU routing for transmission and PDCP PDU reordering for reception)
Duplicate detection function (Duplicate detection of lower layer SDUs at PDCP re-establishment procedure for RLC AM)
Retransmission function (Retransmission of PDCP SDUs at handover and, for split bearers in DC, of PDCP PDUs at PDCP data-recovery procedure, for RLC AM)
Ciphering and deciphering function (Ciphering and deciphering)
Timer-based SDU removal function (Timer-based SDU discard in uplink)

Radio link control (RLC) b-10 and b-35 reconfigure the PDCP packet data unit (PDU) to be the proper size and perform an automatic repeat request (ARQ) operation and the like. Main functions of the RLC are described below.
Data transmission function (Transfer of upper layer PDUs)
ARQ function (Error Correction through ARQ (only for AM data transfer))
Concatenation, segmentation, and reassembly function (Concatenation, segmentation, and reassembly of RLC SDUs (only for UM and AM data transfer))
Re-segmentation function (Re-segmentation of RLC data PDUs (only for AM data transfer))
Reordering function (Reordering of RLC data PDUs (only for UM and AM data transfer))
Duplication detection function (only for UM and AM data transfer)
Error detection function (Protocol error detection (only for AM data transfer))
RLC SDU deletion function (RLC SDU discard (only for UM and AM data transfer))
RLC re-establishment function (RLC re-establishment)

The MACs b-15 and b-30 are connected with various RLC layer devices configured in one UE, and perform operations of multiplexing RLC PDUs to the MAC PDU and demultiplexing the RLC PDUs from the MAC PDU. Main functions of the MAC are described below.
Mapping function (Mapping between logical channels and transport channels)
Multiplexing and demultiplexing function (Multiplexing/demultiplexing of MAC SDUs belonging to one or different logical channels into/from Transport Blocks (TB) delivered to/from the physical layer on transport channels)
Scheduling information report function (Scheduling information reporting)
HARQ function (Error correction through HARQ)
Function of controlling priority between logical channels (Priority handling between logical channels of one UE)
Function of controlling priority between UEs (Priority handling between UEs by means of dynamic scheduling)
MBMS service identification function (MBMS service identification)
Transport format selection function (Transport format selection)
Padding function (Padding)

The PHY layers b-20 and b-25 perform an operation of channel-coding and modulating higher-layer data to generate an OFDM symbol and transmitting the OFDM symbol through a radio channel or demodulating and channel-decoding the OFDM symbol received through the radio channel and transferring the demodulated and channel-decoded OFDM symbol to the higher layer.

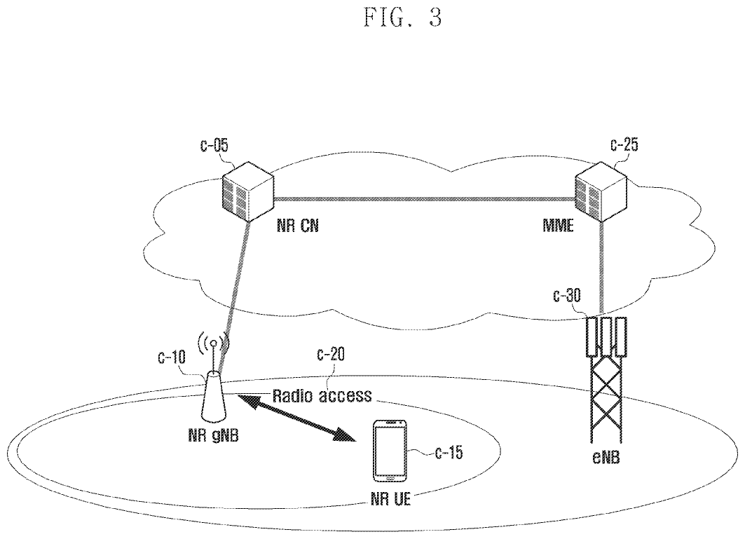

FIG. 3 is a diagram illustrating the structure of a next-generation mobile communication system according to an embodiment of the disclosure.

Referring to FIG. 3, as illustrated, a radio access network of the next-generation mobile communication system (hereinafter, referred to as NR or 5g) is constituted by a next-generation base station c-10 (new radio node B, hereinafter, referred to as an NR gNB or an NR NB) and anew radio core network (NR CN) c-05. A user terminal c-15 (new radio user equipment, hereinafter, referred to as a NR UE or a terminal) accesses an external network through the NR gNB c-10 and the NR CN c-05.

In FIG. 3, the NR gNB c-10 corresponds to an evolved Node B (eNB) of the conventional LTE system. The NR gNB may be connected to the NR UE c-15 through a radio channel and may provide better service than the conventional node B. Since all user traffic is served through a shared channel in the next-generation mobile communication system, a device for collecting and scheduling status information such as buffer statuses of UEs, available transmission power statuses, and channel statuses is required, and the NR NB c-10 serves as the device. One NR gNB generally controls a plurality of cells. The NR gNB may have a bandwidth wider than the conventional maximum bandwidth in order to implement super-high-speed data transmission compared to conventional LTE and may apply Orthogonal Frequency Division Multiplexing (OFDM) through radio access technology and further apply beamforming technology. Further, an adaptive modulation and coding (AMC) scheme of determining a modulation scheme and a channel coding rate is applied depending on the channel status of the UE. The NR CN c-05 performs a function of supporting mobility, configuring bearers, configuring QoS, and the like. The NR CN is a device for performing a function of managing the mobility of the UE and various control functions, and is connected to a plurality of base stations. Further, the next-generation mobile communication system may be linked to the conventional LTE system, and the NR CN is connected to an MME c-25 through a network interface. The MME is connected to an eNB c-30, which is a conventional base station.

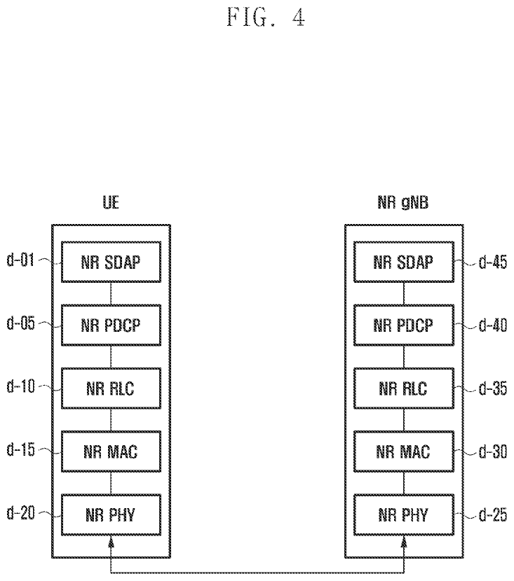

FIG. 4 is a diagram illustrating the wireless protocol structure of the next-generation mobile communication system according to an embodiment of the disclosure.

FIG. 4 is a diagram illustrating the wireless protocol structure of the next-generation mobile communication system to which the disclosure can be applied.

Referring to FIG. 4, the wireless protocol of the next-generation mobile communication system includes NR SDAPs d-01 and d-45, NR PDCPs d-05 and d-40, NR RLCs d-10 and d-35, and NR MACs d-15 and d-30 in the UE and the NR gNB.

Main function of the NR SDAPs d-01 and d-45 may include some of the following functions.
User data transmission function (transfer of user-plane data)
Function of mapping QoS flow and a data bearer for uplink and downlink (mapping between a QoS flow and a DRB for both DL and UL)
Function of marking a QoS flow ID for uplink and downlink (marking QoS flow ID in both DL and UL packets)
Function of mapping reflective QoS flow to a data bearer for uplink SDAP PDUs (reflective QoS flow to DRB mapping for the UL SDAP PDUs)

With respect to the SDAP laver device, the UE may receive a configuration as to whether to use a header of the SDAP layer device or a function of the SDAP layer device for each PDCP layer device, each bearer, or each logical channel through an RRC message. If the SDAP header is configured, a NAS QoS reflection configuration 1-bit indicator (NAS reflective QoS) and a AS QoS reflection configuration 1-bit indicator (AS reflective QoS) of the SDAP header may indicate that the UE updates or reconfigures information on mapping of QoS flow and a data bearer in uplink and downlink. The SDAP header may include QoS flow ID information indicating the QoS. The QoS information may be used as data-processing-priority, scheduling information, or the like to support a seamless service.

Main functions of the NR PDCPs d-05 and d-40 may include some of the following functions.
Header compression and decompression function (Header compression and decompression: ROHC only)
User data transmission function (Transfer of user data)
Sequential delivery function (In-sequence delivery of upper laver PDUs)
Non-sequential delivery function (Out-of-sequence delivery of upper layer PDUs)
Reordering function (PDCP PDU reordering for reception)
Duplicate detection function (Duplicate detection of lower layer SDUs)
Retransmission function (Retransmission of PDCP SDUs)
Ciphering and deciphering function (Ciphering and deciphering)
Timer-based SDU removal function (Timer-based SDU discard in uplink)

The reordering function of the NR PDCP device is a function of sequentially reordering PDCP PDUs received by a lower layer, based on a PDCP sequence number (SN), and may include a function of sequentially delivering the reordered data to a higher layer, a function of directly delivering the recorded data regardless of the order, a function of reordering and recording the lost PDCP PDUs, a function of reporting statuses of the lost PDCP PDUs to a transmitting side, and a function of making a request for retransmitting the lost PDCP PDUs.

Main functions of the NR RLCs d-10 and d-35 may include some of the following functions.
Data transmission function (Transfer of upper layer PDUs)
Sequential delivery function (In-sequence delivery of upper layer PDUs)
Non-sequential delivery function (Out-of-sequence delivery of upper layer PDUs)
ARQ function (Error correction through ARQ)
Concatenation, segmentation, and reassembly function (Concatenation, segmentation, and reassembly of RLC SDUs)
Re-segmentation function (Re-segmentation of RLC data PDUs)
Reordering function (Reordering of RLC data PDUs)
Duplicate detection function (Duplicate detection)
Error detection function (Protocol error detection)
RLC SDU deletion function (RLC SDU discard)
RLC re-establishment function (RLC re-establishment)

The sequential delivery function (In-sequence delivery) of the NR RLC device is a function of sequentially delivering RLC SDUs received from a lower layer to a higher layer, and may include, when one original RLC SDU is divided into a plurality of RLC SDUs and then received, a function of reassembling and delivering the RLC SDUs, a function of reordering the received RLC PDUs, based on an RLC sequence number (SN) or a PDCP sequence number (SN), a function of reordering and recording the lost RLC PDUs, a function of reporting statuses of the lost RLC PDUs to a transmitting side, a function of making a request for retransmitting the lost RLC PDUs, a function of, if there is a lost RLC SDU, sequentially delivering only RLC SDUs preceding the lost RLC SDU to the higher layer, a function of, if a predetermined timer expires even though there is a lost RLC SDU, sequentially delivering all RLC SDUs received before the timer starts to the higher layer, or a function of, if a predetermined timer expires even though there is a lost RLC SDU, sequentially delivering all RLC SDUs received up to now to the higher layer. Further, the NR RLC device may process the RLC PDUs sequentially in a reception order thereof (according to an arrival order regardless of a serial number or a sequence number) and may transfer the RLC PDUs to the PDCP device regardless of the sequence thereof (out-of-sequence delivery). In the case of segments, the NR RLC device may receive segments which are stored in the buffer or will be received in the future, reconfigure the segments to be one RLC PDU, process the RLC PDU, and then transfer the same to the PDCP device. The NR RLC layer may not include a concatenation function, and the function may be performed by the NR MAC layer, or may be replaced with a multiplexing function of the NR MAC layer.

The non-sequential delivery function (Out-of-sequence delivery) of the NR RLC device is a function of transferring RLC SDUs received from a lower layer directly to a higher layer regardless of the sequence thereof, and may include, when one original RLC SDU is divided into a plurality of RLC SDUs and then received, a function of reassembling and transmitting the RLC SDUs and a function of storing RLC SNs or PDCP SNs of the received RLC PDUs, reordering the RLC PDUs, and recording lost RLC PDUs.

The NR MACs d-15 and d-30 may be connected to a plurality of NR RLC layer devices configured in one UE, and the main functions of the NR MACs may include some of the following functions.
Mapping function (Mapping between logical channels and transport channels)
Multiplexing and demultiplexing function (Multiplexing/demultiplexing of MAC SDUs)
Scheduling information report function (Scheduling information reporting)
HARQ function (Error correction through HARQ)
Function of controlling priority between logical channels (Priority handling between logical channels of one UE)
Function of controlling priority between UEs (Priority handling between UEs by means of dynamic scheduling)
MBMS service identification function (MBMS service identification)
Transport format selection function (Transport format selection)
Padding function (Padding)

The NR PHY layers d-20 and d-25 perform an operation of channel-coding and modulating higher-layer data to generate an OFDM symbol and transmitting the OFDM symbol through a radio channel or demodulating and channel-decoding the OFDM symbol received through the radio channel and delivering the demodulated and channel-decoded OFDM symbol to the higher layer.

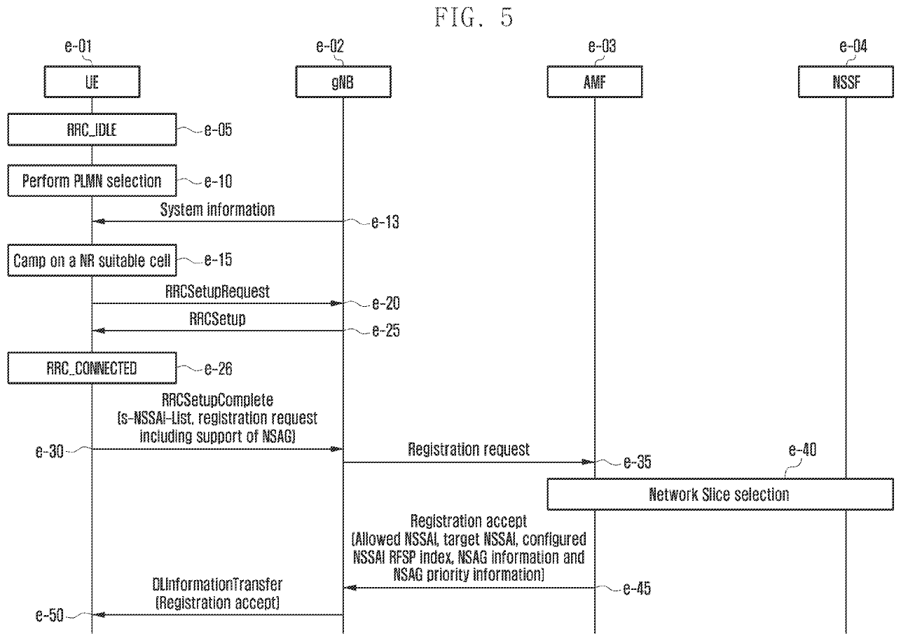

FIG. 5 is a diagram illustrating a process in which the UE receives a configuration of slice groups and a slice group priority through the access and mobility management function (AMF) in the next-generation mobile communication system.

A slice group according to the disclosure may be a configuration by one or a plurality of slices. The slice group may be referred to as a network slice AS group (NSAG). The UE supporting the network slice AS group (NSAG) may receive a configuration of NSAG information and a priority value for each NSAG through a NAS message via the AMF. The NSAG information may be configured for each tracking area (TA). The NSAG information may include at least one of a NSAG identifier (NSAG-Id) for identifying each NSAG, mapping information indicating a NSAG to which a specific slice belongs, and a tracking area identity (TA) for each NSAG. For reference, when the same NSAG identifier is used for each TA but different slice(s) are configured, a TAI may be included. For example, when the TAI is not included in a specific NSAG, it may be indicated that mapping of the same slice(s) is applied to all TAs belonging to a registration area (RA) of the UE.

Referring to FIG. 5, a UE e-01 may be in an RRC-idle mode (RRC_IDLE) in step e-05.

In step e-10, the RRC-idle mode UE e-01 may perform a public land mobile network (PLMN) selection process.

In step e-15, the RRC-idle mode UE e-01 may acquire system information broadcasted by a gNB e-02 in step e-13 and camp on a NR suitable cell through a cell selection or cell reselection process.

The RRC-idle mode UE e-01 may perform a RRC connection setup procedure with the camped-on cell. Specifically, in step e-20, the UE e-01 may transmit a RRC connection setup request message (RRCSetupRequest) to the NR gNB e-02. In step e-25, the NR gNB e-02 may transmit a RRC connection setup message to the UE e-01. The UE e-0I receiving the RRC connection setup message may apply configuration information included in the RRC connection setup message and transition to a RRC-connected mode (RRC_CONNECTED) in step e-26.

In step e-30, the UE e-01 transitioning to the RRC-connected mode may transmit a RRC connection setup complete message to the NR gNB e-02. If a higher-layer device provides one or a plurality of single network slice selection assistance information (S-NSSAI), the UE e-01 may insert S-NSSAI-List into the RRC connection setup complete message through values provided by the higher-layer device and transmit the RRC connection setup complete message to the NR gNB e-02. The S-NSSAI-List is constituted by one or a plurality of S-NSSAIs, each S-NSSAI may be configured by a slice/service type (SST) or the SST and a slice/service type and slice differentiator (SST-SD), and a format of ASN.1 is as shown in [Table 1] below.

TABLE 1
S-NSSAI

The IE S-NSSAI (Single Network Slice Selection Assistance Information) identifies a Network Slice end to end
and comprises a slice/service type and a slice differentiator, see TS 23.003 [21].

S-NSSAI information element

-- ASN [symbol] START
-- TAG-S-NSSAI-START

| | |
|---|---|
| S-NSSAI ::= | CHOICE{ |
| [symbol] | BIT STRING (SIZE ( [symbol] )), |
| [symbol] -SD | BIT STRING (SIZE (32)) |

[symbol]

-- TAG-S-NSSAI-STOP
-- ASN [symbol] STOP

S-NSSAI field descriptions

sst
Indicates the S-NSSAI consisting of Slice/Service Type, see TS 23.003 [21].
sst-SD
Indicates the S-NSSAI consisting of Slice/Service Type and Slice Differentiator, see TS 23.003 [21]. [symbol]
indicates data missing or illegible when filed

In step e-30, the UE e-41 may insert a NAS message (DedicatedNAS-Message) into the RRC connection setup complete message and transmit the RRC connection setup complete message to the NR gNB e-02. For example, the NAS message may be a registration request message. The NAS message may include whether a network slice AS group (NSAG) is supported.

In step e-35, the NR gNB e-02 may forward the registration request message to an AMF e-03.

In step e-40, a network slicing selection function (NSSF) e-04 may select a network slice supportable by the 5G core and transfer the selected network slice to the AMF e-03.

In step e-45, the AMF e-03 may insert at least one of NSAG information of one or a plurality of N-SSAIs and NSAG priority information into a registration accept message and transmit the registration accept message to the NR gNB e-02. The NSAG information may include at least one of the following information.
Mapping information indicating a NSAG to which one or a plurality of slices belongs and an identifier for each NSAG (NSAG-Id)
A maximum of 32 NSAGs may be configured for each PLMN, and the NSAG(s) may be unique for each PLMN.
The information may be configured for each TA.
Tracking area identity (TAI) or TA

For reference, the NSAG information and the NSAG priority information may be provided through a UE configuration command message. In step e-45, the registration accept message may be inserted into unsupportable target NSSAI among NSSAIs requested by the UE e-01 and may be transmitted to the NR gNB e-02. An index to RAT/frequency slice selection priority (hereinafter, referred to as an RFSP index) may also be inserted into the message.

In step e-50, the NR gNB e-02 may transmit a DLInformationTransfer message to the UE e-01. The registration accept message may be inserted into the DLInformationTransfer message.

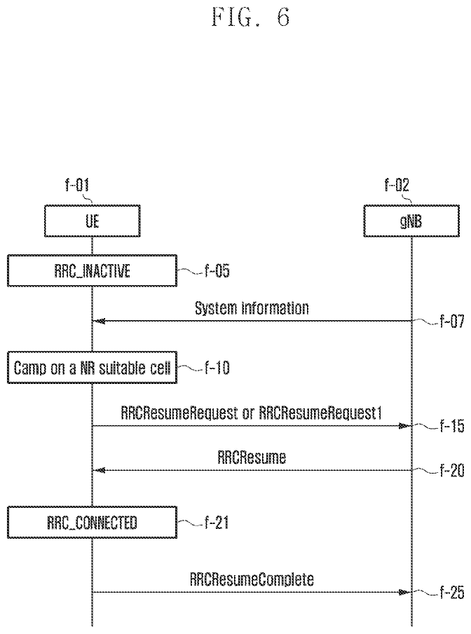

FIG. 6 is a diagram illustrating a method by which the UE reports intended slice information to the gNB in the next-generation mobile communication system.

The slice group according to the disclosure may follow the above-described embodiment.

Referring to FIG. 6, a UE f-01 may be in a RRC-inactive mode (RRC_INACTIVE) in step f-05.

In step f-10, the RRC-inactive mode UE f-01 may acquire system information broadcasted by a NR gNB f-02 in step f-07 and camp on a NR suitable cell through a cell selection or cell reselection process.

The RRC-inactive mode UE f-01 may perform a RRC connection resume procedure with the camped-on cell. Specifically, in step f-15, the UE f-01 may transmit a RRC resume request message (RRCResumeRequest or RRCResumeRequestl) to the NR gNB f-02. In step f-20, the NR gNB f-02 may transmit a RRC connection resume message to the UE f-01. The UE f-01 receiving the RRC connection resume message may apply configuration information included in the RRC connection resume message and transition to a RRC-connected mode (RRC_CONNECTED) in step f-21. In step f-25, the UE f-01 transitioning to the RRC-connected mode may transmit a RRC connection resume completion message to the NR gNB f-02. If a higher-layer device provides one or a plurality of single network slice selection assistance information (S-NSSAI), the UE f-01 may insert S-NSSAI-List into the RRC connection setup complete message through values provided by the higher-layer device and transmit the RRC connection setup complete message to the NR gNB f-02. The S-NSSAI-List is constituted by one or a plurality of S-NSSAIs, each S-NSSAI may be configured by a slice/service type (SST) or the SST and a slice/service type and slice differentiator (SST-SD), and a format of ASN.1 is as shown in [Table 2] below.

TABLE 2
S-NSSAI

The IE S-NSSAI (Single Network Slice Selection Assistance Information) identifies a Network
Slice end to end and comprises a slice/service type and a slice differentiator, see TS 23.003
[21].

S-NSSAI information element

-- ASN [symbol] START
-- TAG-S-NSSAI-START

| | |
|---|---|
| S-NSSAI ::= | CHOICE{ |
| [symbol] | BIT STRING (SIZE ( [symbol] )), |
| [symbol] -SD | BIT STRING (SIZE (32)) |

[symbol]

-- TAG-S-NSSAI-STOP
-- ASN [symbol] STOP

S-NSSAI field descriptions

sst
Indicates the S-NSSAI consisting of Slice/Service Type, see TS 23.003 [21].
sst-SD
Indicates the S-NSSAI consisting of Slice/Service Type and Slice Differentiator, see TS 23.003 [21]. [symbol]
indicates data missing or illegible when filed

In step f-25, the UE f-01 may include one of at least the following information in the RRC connection resume complete message.
NSAG information for one or a plurality of N-SSAIs. The NSAG information may be slice(s) intended by the UE.
Priority information according to each NSAG information

In step f-25, the UE f-01 may insert a NAS message (DedicatedNAS-Message) into the RRC connection setup complete message and transmit the RRC connection setup completion message to the NR gNB f-02. For example, the NAS message may be a registration request message or a service request message. The NAS message may include at least one of the NSAG information described above, priority information according to the NSAG information, and s-NSSAI-List.

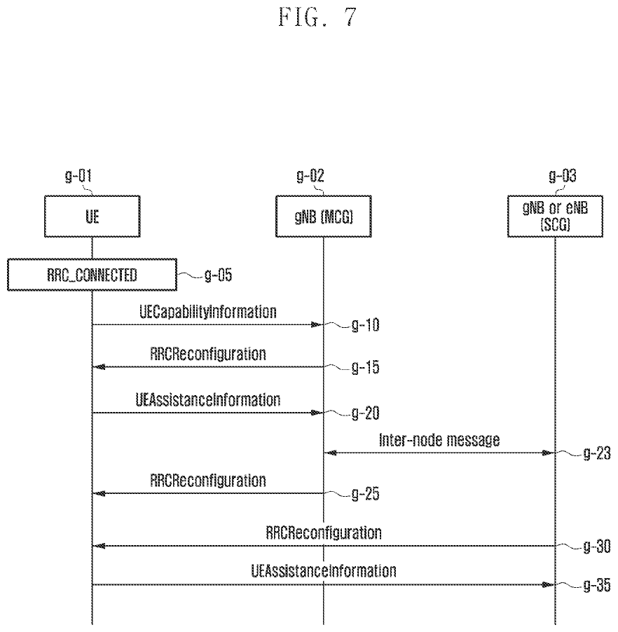

FIG. 7 is a diagram illustrating a method by which the UE reports intended slice information to the gNB in the next-generation mobile communication system.

The slice group according to the disclosure may follow the above-described embodiment.

Referring to FIG. 7, a UE g-01 may be in a RRC-connected mode (RRC_CONNECTED) in step g-05.

In step g-10, the RRC-connected mode UE g-01 may transmit a UE capability information message (UECapabilityInformation) to a NR gNB g-02. The message may include at least one of the following information.
An indicator indicating a capability for transmitting preference of an intended slice or an intended slice group of the UE to the gNB. The indicator may be applied only to a master cell group or applied for each cell group (in which case the indicator may mean a separate indicator).
An indicator indicating a capability for transmitting priority preference of the intended slice or the intended slice group when preference of the intended slice or intended slice group of the UE is transmitted to the gNB.

In step g-15, the NR gNB g-02 may transmit a RRC connection reconfiguration message (RRCReconfiguration) to the RRC-connected mode UE g-01. The message may include otherConfig. The otherConfig may include at least one of the following information.
An indicator indicating whether the UE can transmit preference of the intended slice or the intended slice group to the gNB
A prohibit timer value
Information on how much preference of the intended slice or the intended slice group can be transmitted by the UE

In step g-20, the UE g-01 may transmit a UEAssistanceInformation message to the NR gNB g-02. The message may include at least one of the following information.
Information on a list of intended slices or intended slice groups preferred by the UE
Individual priority information for each intended slice or the list of intended slice groups. The individual priority information may be explicitly indicated or may include a list of intended slices or intended slice groups sequentially in the order of high priority.

For reference, in step g-20, when transmitting the UEAssistanceInformation message including the information, the UE g-01 may run a prohibit timer. When the prohibit timer is running, the UEAssistanceInformation message including the information cannot be transmitted to the NR gNB g-02. For example, when the UE g-0l never transmitted the UEAssistanceInformation message including the information or is not running the prohibit timer, the UEInformation message including the information may be transmitted to the NR gNB g-02.

In step g-23, the NR gNB g-02 and a NR gNB or an LTE eNB g-03 may exchange the information received at step g-20. For example, the NR gNB g-02 may negotiate intended slice or intended slice group information with the NR gNB or LTE eNB g-03.

In step g-25, the NR gNB g-02 may transmit a RRC connection reconfiguration message to the UE g-01 in order to configure a SCell or a SCG, based on the information received at step g-20. For example, the NR gNB g-02 may configure carrier aggregation (CA) or dual connectivity (DC) in the UE g-01.

In step g-30, the NR gNB or LTE eNB g-03 that manages a secondary cell group may transmit the RRC connection reconfiguration message including otherConfig to the UE g-01. The transmission of the RRC connection reconfiguration message including otherConfig may follow the above-described step (for example, g-15).

In step g-35, the UE g-01 performing the DC operation may transmit the UEAssistanceInformation message to the NR gNB or LTE eNB g-03. The transmission of the UEAssistanceInformation message may follow the above-described step (for example, g-20).

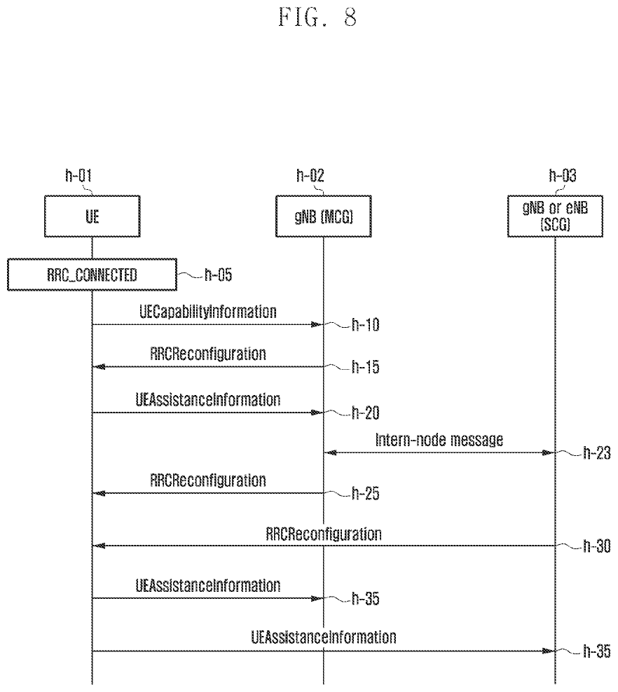

FIG. 8 is a diagram illustrating a method by which the UE reports intended slice information to the gNB in the next-generation mobile communication system.

The slice group according to the disclosure may follow the above-described embodiment.

Referring to FIG. 8, a UE h-01 may be in a RRC-connected mode (RRC_CONNECTED) in step h-05.

In step h-10, the RRC-connected mode UE h-01 may transmit a UE capability information message (UECapabilityInformation) to a NR gNB h-02. The message may include at least one of the following information.
An indicator indicating a capability for transmitting preference of an intended slice or an intended slice group of the UE to the gNB. The indicator may be applied only to a master cell group or applied for each cell group (in which case the indicator may mean a separate indicator).
An indicator indicating a capability for transmitting priority preference of the intended slice or the intended slice group when preference of the intended slice or the intended slice group of the UE is transmitted to the NR gNB.
An indicator indicating a capability that may make a request for activating a Scell (or SCG) supporting the intended slice or the intended slice group by the UE

In step h-15, the NR gNB h-02 may transmit a RRC connection reconfiguration message (RRCReconfiguration) to the UE h-01 and configure one or a plurality of secondary cells (SCells, primary cells, or primary secondary cells) as a deactivated state. Alternatively, through the RRC connection reconfiguration message, slice or slice group information supported by each SCell may be included.

In step h-20, the UE h-01 may make a request for activating one or a plurality of SCells to the NR gNB h-02. For example, in order to receive supporting of the intended slice or slice group, the UE h-01 may make a request for activating one or a plurality of SCells to the NR gNB h-02. The request message may be a MAC CE or a RRC message (for example, UEAssistanceInformation). The message may include at least one of the following information.
Information on a list of intended slices or intended slice groups preferred by the UE
Individual priority information for each intended slice or the list of intended slice groups. The individual priority information may be explicitly indicated or may include a list of intended slices or intended slice groups sequentially in the order of high priority.

For reference, in step h-20, when transmitting the UEAssistanceInformation message including the information, the UE h-01 may run a prohibit timer. When the prohibit timer is running, the UE h-01 may not transmit the UEAssistanceInformation message including the information to the NR gNB h-02. For example, when the UE h-01 never transmitted the UEAssistanceInformation message including the information or is not running the prohibit timer, the UEInformation message including the information may not be transmitted to the NR gNB h-02.

In step h-23, the NR gNB h-02 and a NR gNB or LTE eNB h-03 may exchange the information received at step h-20. For example, the NR gNB h-02 may negotiate intended slice or intended slice group information with the NR gNB or LTE eNB h-03.

In step h-25, the NR gNB h-02 may transmit a RRC connection reconfiguration message to the UE h-0l in order to configure a SCell, based on the information received at step h-20. For example, the NR gNB h-02 may configure carrier aggregation (CA) or dual connectivity (DC) in the UE h-01 or may modify the pre-configured information (CA or DC).

In step h-30, the NR gNB or LTE eNB h-03 that manages a secondary cell group may transmit the RRC connection reconfiguration message including otherConfig to the UE h-01. The transmission of the RRC connection reconfiguration message including otherConfig may follow the above-described step (for example, h-15).

In step h-35, the UE h-01 may transmit a UEAssistanceInformation message to the NR gNB h-02. Alternatively, the UE h-01 performing the CA or DC operation may transmit the UEAssistanceInformation message to the NR gNB or LTE eNB h-03. The transmission of the UEAssistanceInformation message may follow the above-described step (for example, h-20).

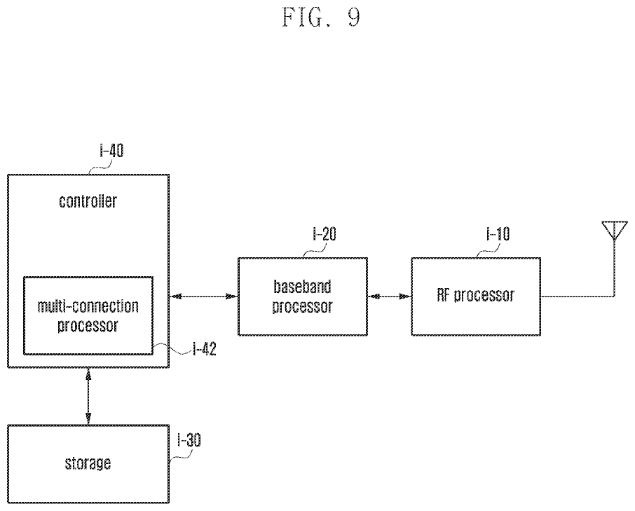

FIG. 9 is a block diagram illustrating an internal structure of the UE according to an embodiment of the disclosure.

Referring to the above drawing, the UE includes a radio-frequency (RF) processor i-10, a baseband processor i-20, a storage i-30, and a controller i-40.

The RF processor i-10 performs a function of transmitting and receiving a signal through a radio channel such as signal band conversion or amplification. For example, the RF processor i-10 may up-convert a baseband signal provided from the baseband processor i-20 into an RF band signal and then transmit the RF band signal through an antenna, and down-convert the RF band signal received through the antenna into the baseband signal. For example, the RF processor i-10 may include a transmission filter, a reception filter, an amplifier, a mixer, an oscillator, a digital-to-analog convertor (DAC), an analog-to-digital convertor (ADC), and the like. Although only one antenna is illustrated in FIG. 9, the UE may include a plurality of antennas. Further, the RF processor i-10 may include a plurality of RF chains. Moreover, the RF processor i-10 may perform beamforming. For the beamforming, the RF processor i-10 may control a phase and a size of each signal transmitted and received through a plurality of antennas or antenna elements. The RF processor may perform MIMO and receive a plurality of layers when performing the MIMO operation.

The baseband processor i-20 performs a function for a conversion between a baseband signal and a bitstream according to a physical layer standard of the system. For example, in data transmission, the baseband processor i-20 generates complex symbols by encoding and modulating a transmission bitstream. In data reception, the baseband processor i-20 reconstructs a reception bitstream by demodulating and decoding a baseband signal provided from the RF processor i-10. For example, in an orthogonal frequency-division multiplexing (OFDM) scheme, when data is transmitted, the baseband processor i-20 generates complex symbols by encoding and modulating a transmission bitstream, maps the complex symbols to subcarriers, and then configures OFDM symbols through an inverse fast Fourier transform (IFFT) operation and a cyclic prefix (CP) insertion. Further, when data is received, the baseband processor i-20 divides the baseband signal provided from the RF processor i-10 in the unit of OFDM symbols, reconstructs the signals mapped to the subcarriers through a fast Fourier transform (FFT) operation, and then reconstructs a reception bitstream through demodulation and decoding.

The baseband processor i-20 and the RF processor i-10 transmit and receive signals as described above. Accordingly, the baseband processor i-20 and the RF processor i-10 may be referred to as transmitters, receivers, transceivers, or communicators. At least one of the baseband processor i-20 and the RF processor i-10 may include a plurality of communication modules to support a plurality of different radio access technologies. Further, at least one of the baseband processor i-20 and the RF processor i-10 may include different communication modules to process signals in different frequency bands. For example, the different radio access technologies may include a wireless LAN (for example, IEEE 802.11) and a cellular network (for example, LTE). Further, the different frequency bands may include a super high frequency (SHF) (for example, 2.NRHz, NRhz) band and a millimeter (mm) wave (for example, 60 GHz) band.

The storage i-30 stores data such as a basic program for the operation of the UE, an application program, and configuration information. Particularly, the storage i-30 may store information related to a second access node that performs wireless communication using a second radio access technology. The storage i-30 provides stored data according to a request from the controller i-40.

The controller i-40 controls the overall operation of the UE. For example, the controller i-40 transmits and receives signals through the baseband processor i-20 and the RF processor i-10. The controller i-40 records data in the storage i-40 and read the data. To this end, the controller i-40 may include at least one processor. For example, the controller i-40 may include a communications processor (CP) that performs control for communication, and an application processor (AP) that controls higher layers such as an application program.

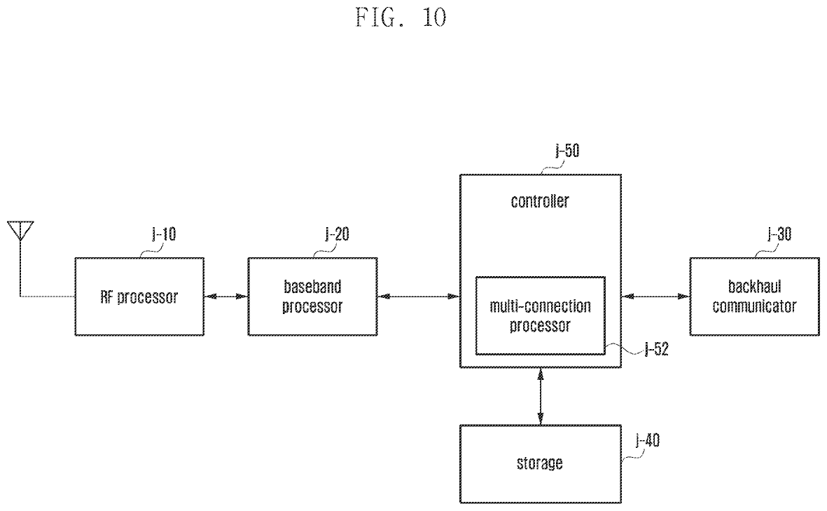

FIG. 10 is a block diagram illustrating a configuration of a base station according to an embodiment of the disclosure.

As illustrated in the above drawing, the base station includes an RF processor j-10, a baseband processor j-20, a backhaul communicator j-30, a storage j-40, and a controller j-50.

The RF processor j-10 performs a function of transmitting and receiving a signal through a radio channel such as signal band conversion or amplification. For example, the RF processor j-10 up-converts a baseband signal provided from the baseband processor j-20 into an RF band signal and then transmits the RF band signal through an antenna, and down-converts the RF band signal received through the antenna into the baseband signal. For example, the RF processor j-10 may include a transmission filter, a reception filter, an amplifier, a mixer, an oscillator, a DAC, an ADC, and the like. Although only one antenna is illustrated in the above drawing, the first access node may include a plurality of antennas. The RF processor j-10 may include a plurality of RF chains. Further, the RF processor j-10 may perform beamforming. For the beamforming, the RF processor j-10 may control a phase and a size of each of the signals transmitted and received through a plurality of antennas or antenna elements. The RF processor may perform a downlink MIMO operation by transmitting one or more layers.

The baseband processor j-20 performs a function for conversion between a baseband signal and a bitstream according to a physical layer standard of the first radio access technology. For example, in data transmission, the baseband processor j-20 generates complex symbols by encoding and modulating a transmission bitstream. Further, in data reception, the baseband processor j-20 reconstructs a reception bitstream by demodulating and decoding a baseband signal provided from the RF processor j-10. For example, in an OFDM scheme, when data is transmitted, the baseband processor j-20 generates complex symbols by encoding and modulating the transmission bitstream, map the complex symbols to subcarriers, and then configure OFDM symbols through an IFFT operation and CP insertion. In addition, when data is received, the baseband processor j-20 divides a baseband signal provided from the RF processor j-10 in units of OFDM symbols, reconstructs signals mapped with subcarriers through an FFT operation, and then reconstructs a reception bitstream through demodulation and decoding. The baseband processor j-20 and the RF processor j-10 may transmit and receive the signal as described above. Accordingly, the baseband processor j-20 and the RF processor j-10 may be referred to as transmitter, receivers, transceivers, communicators, or wireless communicators.

The backhaul communicator j-30 provides an interface for communicating with other nodes within the network. For example, the backhaul communicator j-30 converts a bitstream transmitted from the main base station to another node, for example, a secondary base station, a core network, or the like into a physical signal and converts the physical signal received from the other node into the bitstream.

The storage j-40 stores data such as a basic program for the operation of the main base station, an application program, and configuration information. Particularly, the storage j-40 may store information on bearers allocated to the accessed UE, measurement result reported from the accessed UE, and the like. Further, the storage j-40 may store information that is a reference for providing multiple connections to the UE or stopping the connections. The storage j-40 provides stored data according to a request from the controller j-50.

The controller j-50 controls the overall operation of the main base station. For example, the controller j-50 transmits and receives signals through the baseband processor j-20 and the RF processor j-10 or through the backhaul communicator j-30. Further, the controller j-50 records data in the storage j-40 and reads the data. To this end, the controller j-50 may include at least one processor.

Methods according to embodiments stated in the claims or specifications of the disclosure may be implemented in the form of hardware, software, or a combination of hardware and software.

When the methods are implemented in software, a computer-readable storage medium for storing one or more programs (software modules) may be provided. The one or more programs stored in the computer-readable storage medium may be configured for execution by one or more processors within the electronic device. The one or more programs may include instructions that cause the electronic device to perform methods according to embodiments stated in the claims or specifications of the disclosure.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, the programs may be stored in a memory including any combination of some or all thereof. Furthermore, the number of such memories may be plural.

In addition, the programs may be stored in an attachable storage device which may access the electronic device through communication networks such as the Internet, an Intranet, a local area network (LAN), wide LAN (WLAN), and a storage area network (SAN), or communication networks constituted by a combination thereof. The storage device may access a device implementing embodiments of the disclosure through an external port. Further, a separate storage device in a communication network may access the device implementing embodiments of the disclosure.

In the above-described detailed embodiments of the disclosure, the number of components included in the disclosure is expressed in the singular or the plural according to a presented detailed embodiment. However, the singular or plural expression is selected to be suitable for a presented situation for convenience of description, the disclosure is not limited to a singular component or plural components, and even components expressed in the plural form may be configured in the singular form or even components expressed in the singular form may be configured in the plural form.

Meanwhile, although the embodiment has been described in the detailed description of the disclosure, the disclosure can be modified in various forms without departing from the scope of the disclosure. Therefore, the scope of the disclosure should not be defined as being limited to the embodiments, but should be defined by the appended claims and equivalents thereof.

1. A method performed by a terminal in a wireless communication system, the method comprising:
transmitting, to a first base station (BS), terminal capability information indicating whether a report on preference information associated with intended slice group information of the terminal is supported;
receiving, from the first BS, a first radio resource control (RRC) reconfiguration message comprising configuration information for the report on the preference information associated with the intended slice group information; and
transmitting, to the first BS, a first message comprising the preference information associated with the intended slice group information, based on the configuration information.

2. The method of claim 1, further comprising:
receiving, from the first BS, a second RRC reconfiguration message for configuring at least one secondary cell (scell), based on the preference information associated with the intended slice group information included in the first message;
receiving a third RRC reconfiguration message comprising the configuration information for the report on the preference information associated with the intended slice group information from a second BS corresponding to the scell, and
transmitting, to the second BS, a message comprising the preference information associated with the intended slice group information, based on the configuration information.

3. The method of claim 1, further comprising:
receiving a fourth RRC reconfiguration message comprising configuration information for configuring at least one scell as a deactivated state and information on slice groups supported by each of the at least one scell from the first BS receiving the terminal capability information; and
transmitting, to the first BS, a second message making a request for activating one or more scells comprising the preference information associated with the intended slice group information, based on the configuration information and the information on the slice groups supported by each of the at least one scell.

4. The method of claim 3, further comprising:
receiving, from the first BS, a fifth RRC reconfiguration message for configuring the one or more scells, based on the second message:
receiving a sixth RRC reconfiguration message comprising the configuration information for the report on the preference information associated with the intended slice group information from a third BS corresponding to the one or more scells; and
transmitting a message comprising the preference information associated with the intended slice group information to at least one of the first BS and the third BS, based on the configuration information.

5. A method performed by a first base station (BS) in a wireless communication system, the method comprising:
receiving, from a terminal, terminal capability information indicating whether a report on preference information associated with intended slice group information of the terminal is supported,
generating a first radio resource control (RRC) reconfiguration message comprising configuration information for the report on the preference information associated with the intended slice group information and transmitting the first RRC reconfiguration message to the terminal; and
receiving, from the terminal, a first message comprising the preference information associated with the intended slice group information identified based on the configuration information.

6. The method of claim 5, further comprising:
transmitting the preference information associated with the intended slice group information received from the terminal to a second BS corresponding to at least one secondary cell (scell); and
transmitting, to the terminal, a second RRC reconfiguration message for configuring the at least one scell, based on the preference information associated with the intended slice group information included in the first message,
wherein a third RRC reconfiguration message comprising the configuration information for the report on the preference information associated with the intended slice group information is transmitted from the second BS to the terminal, and a message comprising the preference information associated with the intended slice group information is transmitted from the terminal to the second BS, based on the configuration information.

7. The method of claim 5, further comprising:
transmitting, to the terminal, a fourth RRC reconfiguration message comprising configuration information for configuring at least one scell as a deactivated state and information on slice groups supported by each of the at least one scell; and
receiving, from the terminal, a second message making a request for activating one or more scells comprising the preference information associated with the intended slice group information, based on the configuration information and the information on the slice groups supported by each of the at least one scell.

8. The method of claim 7, further comprising transmitting, to the terminal, a fifth RRC reconfiguration message for configuring the one or more scells, based on the second message,
wherein a sixth RRC reconfiguration message comprising the configuration information for the report on the preference information associated with the intended slice group information is transmitted from a third BS corresponding to the one or more scells to the terminal, and
a message comprising the preference information associated with the intended slice group information is transmitted from the terminal to at least one of the first BS and the third BS, based on the configuration information.

9. A terminal in a wireless communication system, the terminal comprising:
a transceiver; and
a controller configured to perform control to:
transmit terminal capability information indicating whether a report on preference information associated with intended slice group information of the terminal is supported to a first base station (BS) through the transceiver;
receive a first radio resource control (RRC) reconfiguration message comprising configuration information for the report on the preference information associated with the intended slice group information from the first BS through the transceiver; and
transmit a first message comprising the preference information associated with the intended slice group information to the first BS through the transceiver, based on the configuration information.

10. The terminal of claim 9, wherein the controller is configured to perform control to:
receive a second RRC reconfiguration message for configuring at least one secondary cell (scell) from the first BS through the transceiver, based on the preference information associated with the intended slice group information included in the first message;
receive a third RRC reconfiguration message comprising the configuration information for the report on the preference information associated with the intended slice group information from a second BS corresponding to the scell; and
transmit a message comprising the preference information associated with the intended slice group information to the second BS through the transceiver, based on the configuration information

11. The terminal of claim 10, wherein the controller is configured to perform control to:
receive a fourth RRC reconfiguration message comprising configuration information for configuring at least one scell as a deactivated state and information on slice groups supported by each of the at least one scell from the first BS receiving the terminal capability information through the transceiver; and
transmit a second message making a request for activating one or more scells comprising the preference information associated with the intended slice group information to the first BS through the transceiver, based on the configuration information and the information on the slice groups supported by each of the at least one scell.

12. The terminal of claim 11, wherein the controller is configured to perform control to:
receive a fifth RRC reconfiguration message for configuring the one or more scells from the first BS through the transceiver, based on the second message;
receive a sixth RRC reconfiguration message comprising the configuration information for the report on the preference information associated with the intended slice group information from a third BS corresponding to the one or more scells through the transceiver; and
transmit a message comprising the preference information associated with the intended slice group information to at least one of the first BS and the third BS through the transceiver, based on the configuration information.

13. A first base station (BS) in a wireless communication system, the first BS comprising:
a transceiver; and
a controller configured to perform control to:
receive terminal capability information indicating whether a report on preference information associated with intended slice group information of a terminal is supported from the terminal through the transceiver;
generate a first radio resource control (RRC) reconfiguration message comprising configuration information for the report on the preference information associated with the intended slice group information and transmitting the first RRC reconfiguration message to the terminal through the transceiver; and
receive a first message comprising the preference information associated with the intended slice group information identified based on the configuration information from the terminal through the transceiver.

14. The first BS of claim 13, wherein the controller is configured to perform control to:
transmit the preference information associated with the intended slice group information received from the terminal to a second BS corresponding to at least one secondary cell (scell) through the transceiver; and
transmit a second RRC reconfiguration message for configuring the at least one scell to the terminal through the transceiver, based on the preference information associated with the intended slice group information included in the first message,
wherein a third RRC reconfiguration message comprising the configuration information for the report on the preference information associated with the intended slice group information is transmitted from the second BS to the terminal, and a message comprising the preference information associated with the intended slice group information is transmitted from the terminal to the second BS, based on the configuration information.

15. The first BS of claim 13, wherein the controller is configured to perform control to:
transmit a fourth RRC reconfiguration message comprising configuration information for configuring at least one scell as a deactivated state and information on slice groups supported by each of the at least one scell to the terminal through the transceiver;
receive a second message making a request for activating one or more scells comprising the preference information associated with the intended slice group information from the terminal through the transceiver, based on the configuration information and the information on the slice groups supported by each of the at least one scell; and
transmit a fifth RRC reconfiguration message for configuring the one or more scells to the terminal through the transceiver, based on the second message,
wherein a sixth RRC reconfiguration message comprising the configuration information for the report on the preference information associated with the intended slice group information is transmitted from a third BS corresponding to the one or more scells to the terminal, and
a message comprising the preference information associated with the intended slice group information is transmitted from the terminal to at least one of the first BS and the third BS, based on the configuration information.
